(19) United States
(12) Patent Application Publication
(10) Pub. No.: US 2024/0085561 A1
(43) Pub. Date: Mar. 14, 2024

(54) IMAGE SENSOR FOR DISTANCE MEASUREMENT AND CAMERA MODULE INCLUDING THE SAME

(71) Applicant: Samsung Electronics Co., Ltd., Suwon-si (KR)

(72) Inventors: Jiheon PARK, Suwon-si (KR); Seungchul SHIN, Suwon-si (KR); Myoungoh KI, Suwon-si (KR)

(73) Assignee: Samsung Electronics Co., Ltd., Suwon-si (KR)

(21) Appl. No.: 18/461,984

(22) Filed: Sep. 6, 2023

(30) Foreign Application Priority Data
Sep. 8, 2022 (KR) 10-2022-0114470
Oct. 24, 2022 (KR) 10-2022-0137652

(51) Int. Cl. G01S 17/89; G01B 11/22; G01S 7/481; G01S 7/4911; G01S 7/4915; G01S 7/497; G06T 7/80; H04N 25/78

(52) U.S. Cl. CPC G01S 17/89; G01B 11/22; G01S 7/4816; G01S 7/4911; G01S 7/4915; G01S 7/497; G06T 7/80; H04N 25/78; G06T 2207/10028

(57) ABSTRACT

Provided are image sensors for distance measurement and camera modules. The image sensors for distance measurement include a pixel array including a plurality of unit pixels, a readout circuit configured to read out pixel signals from the pixel array in units of sub-frames and generate raw data, a preprocessing circuit configured to preprocess the raw data to generate phase data, a memory configured to store the phase data, a calibration circuit configured to generate correction data by performing a calibration operation on the phase data, an image signal processor configured to generate depth information using the correction data, and an output interface circuit configured to output depth data including the depth information in units of depth frames.

### CROSS-REFERENCE TO RELATED APPLICATION

This application is based on and claims priority under 35 U.S.C. § 119 to Korean Patent Application No. 10-2022-0137652, filed on Oct. 24, 2022, in the Korean Intellectual Property Office, and Korean Patent Application No. 10-2022-0114470, filed on Sep. 8, 2022, in the Korean Intellectual Property Office, the disclosures of which are incorporated by reference herein in their entireties.

### BACKGROUND

The present inventive concepts relate to s image sensors, and more particularly, to image sensors for distance measurement and camera modules including the image sensors.

Time-of-flight (ToF) image sensors may generate 3D images of objects by measuring information on the distances to the objects. ToF image sensors may obtain information on the distance to an object by measuring the time of flight between the emission of light toward the object and the return of light reflected from the object. Distance information includes noise due to various factors, and thus, it is necessary to minimize noise to obtain accurate distance information.

### SUMMARY

The inventive concepts provide mage sensors configured to output depth data including depth information for distance measurement, and camera modules including the image sensors.

According to some aspects of the inventive concepts, there is provided an image sensor for distance measurement, the image sensor including a pixel array including a plurality of unit pixels, a readout circuit configured to read out pixel signals from the pixel array in units of sub-frames and generate raw data, a preprocessing circuit configured to preprocess the raw data to generate phase data, a memory configured to store the phase data, a calibration circuit configured to generate correction data by performing a calibration operation on the phase data, an image signal processor configured to generate depth information using the correction data, and an output interface circuit configured to output depth data including the depth information in units of depth frames.

According to some aspects of the inventive concepts, there is provided a camera module including a light source unit configured to transmit an optical transmission signal to an object, and an image sensor configured to receive an optical reception signal reflected from the object, wherein the image sensor includes a pixel array including a plurality of unit pixels, a control circuit configured to transmit a modulation signal to the light source unit and a plurality of demodulation signals to the pixel array, the modulation signal and the plurality of demodulation signals having an identical modulation frequency, a readout circuit configured to read out pixel signals from the pixel array in units of sub-frames and generate raw data, a preprocessing circuit configured to preprocess the raw data to generate phase data, a frame memory configured to store the phase data, an image signal processor configured to generate depth information based on the phase data, and an output interface circuit configured to output depth data including the depth information in units of depth frames.

According to some aspects of the inventive concepts, there is provided a camera module including a light source unit configured to transmit an optical transmission signal to an object, and an image sensor configured to receive an optical reception signal reflected from the object, wherein the image sensor includes a pixel array including a plurality of unit pixels, a control circuit configured to transmit a modulation signal to the light source unit and a plurality of demodulation signals to the pixel array, the modulation signal and the plurality of demodulation signals having an identical modulation frequency, a readout circuit configured to read out pixel signals from the pixel array and generate raw data, a preprocessing circuit configured to preprocess the raw data to generate phase data, a memory configured to store the phase data, a calibration circuit configured to generate correction data by performing a calibration operation on the phase data based on calibration information, an image signal processor configured to generate depth information using the correction data, and an output interface circuit configured to output depth data including the depth information.

### BRIEF DESCRIPTION OF THE DRAWINGS

Example embodiments will be more clearly understood from the following detailed description taken in conjunction with the accompanying drawings in which:

FIG. 1 is a configuration diagram illustrating a system according to some example embodiments;

FIG. 2 is a configuration diagram illustrating a camera module according to some example embodiments;

FIG. 3A is a diagram illustrating an example structure of a unit pixel shown in FIG. 2, according to some example embodiments;

FIG. 3B is a diagram illustrating an example structure of a unit pixel shown in FIG. 2, according to some example embodiments;

FIGS. 4A and 4B are block diagrams illustrating schematic configurations of systems according to some example embodiments;

FIG. 5 is a diagram illustrating calibration information stored in memories;

FIG. 6 is a diagram illustrating an operation of an image sensor according to the inventive concepts with timing charts showing frequencies of first to fourth photogate signals;

FIG. 7 is a diagram illustrating a shuffle operation of the image sensor according to the inventive concepts;

FIG. 8A is a timing diagram illustrating an operation of an image sensor according to a comparative example, and FIG. 8B is a diagram illustrating an operation of the image sensor according to the inventive concepts;

FIGS. 9A to 9C are diagrams illustrating operations of image sensors according to the inventive concepts; and

FIGS. 10 and 11 are schematic diagrams illustrating image sensors according to some example embodiments.

### DETAILED DESCRIPTION

Hereinafter, some example embodiments will be described with reference to the accompanying drawings.

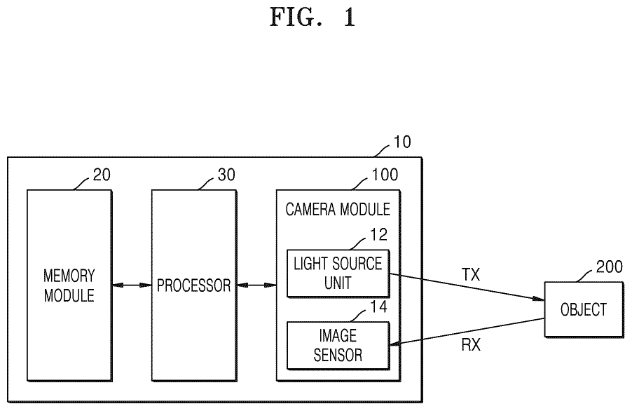

FIG. 1 is a block diagram illustrating a schematic configuration of a system 10 according to some example embodiments.

Referring to FIG. 1, the system 10 may include a processor 30 and a camera module 100. In some example embodiments, the camera module 100 may transmit image data including depth data. The system 10 may further include a memory module 20 connected to the processor 30 and configured to store information such as image data including depth data received from the camera module 100.

In some example embodiments, the system 10 may be integrated into a single semiconductor chip, or the camera module 100, the processor 30, and the memory module 20 may be implemented as separate semiconductor chips, respectively. The memory module 20 may include one or more memory chips. In some example embodiments, the processor 30 may include multiple processing chips.

The system 10 may be an electronic device to which a distance-measuring image sensor is applicable according to some example embodiments. The system 10 may be of a portable type or a stationary type. Examples of the portable type include mobile devices, cellular phones, smartphones, user equipment (UE), tablets, digital cameras, laptop or desktop computers, electronic smartwatches, machine-to-machine (M2M) communication devices, virtual reality (VR) devices or modules, robots, and/or the like. Examples of the stationary type include game consoles in video game centers, interactive video terminals, automobiles, machine vision systems, industrial robots, VR devices, driver-side cameras, and/or the like.

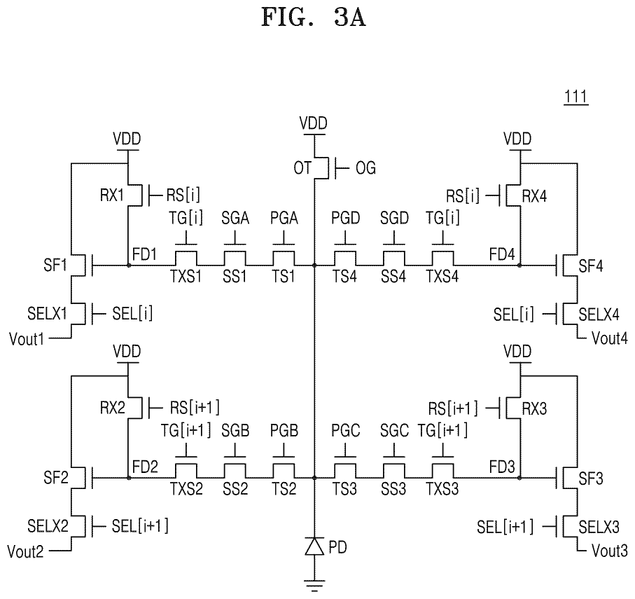

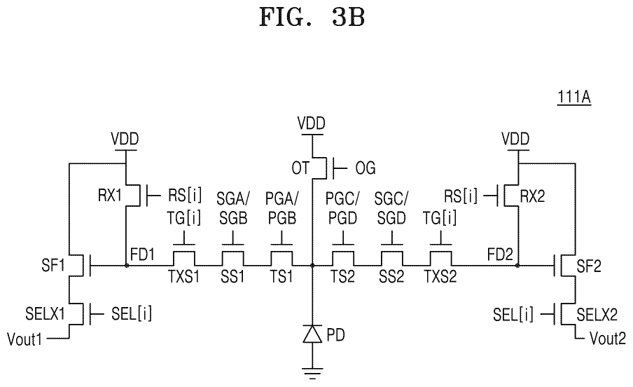

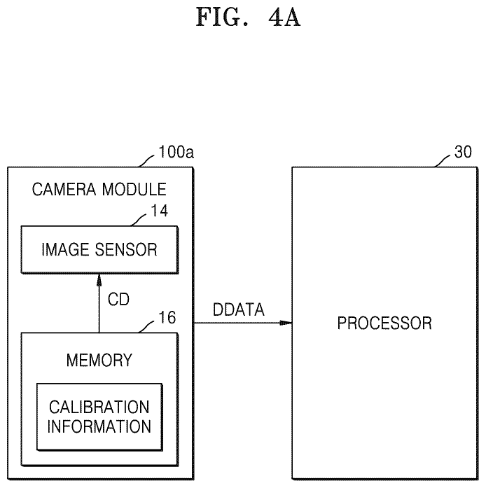

The camera module 100 may include a light source unit 12 and an image sensor 14. The light source unit 12 may transmit optical transmission signal TX to an object 200. For example, the optical transmission signal TX may be a sinusoidal wave signal. The optical transmission signal TX transmitted from the light source unit 12 to the object 200 may be reflected by the object 200, and then the image sensor 14 may receive the reflected optical transmission signal TX as an optical reception signal RX. The image sensor 14 may obtain, based on time-of-flight (ToF), depth information which is information about the distance to the object 200. The structures of the light source unit 12 and the image sensor 14 are described below with reference to FIGS. 3A and 3B.

The processor 30 may include a general-purpose processor such as a central processing unit (CPU). In some example embodiments, besides the CPU, the processor 30 may further include a microcontroller, a digital signal processor (DSP), a graphics processing unit (GPU), an application specific integrated circuit (ASIC) processor, and/or the like. In addition, the processor 30 may include two or more CPUs configured to operate in a distributed processing environment. In some example embodiments, the processor 30 may be a system-on-chip (SoC) having a CPU function and other additional functions, or may be an application processor (AP) of a smartphone, a tablet computer, a smartwatch, and/or the like.

The processor 30 may control operations of the camera module 100. In some example embodiments, the system 10 may include a plurality of camera modules. In this case, the processor 30 may receive depth data from the image sensor 14 of the camera module 100 and may merge the depth data with image data received from camera modules (e.g., camera module 100 and/or additional camera modules not shown) to generate a 3D depth image. The processor 30 may display the 3D depth image on a display screen (not shown) of the system 10.

The processor 30 may be programmed with software or firmware for various processing tasks. In some example embodiments, the processor 30 may include programmable hardware logic circuits configured to perform some or all of the functions of the processor 30. For example, the memory module 20 may store program code, lookup tables, or intermediate calculation results such that the processor 30 may perform a corresponding function.

Examples of the memory module 20 may include dynamic random access memory (DRAM) modules such as synchronous DRAM (SDRAM) modules; high bandwidth memory (HBM) modules; and DRAM-based 3D stack (3DS) memory modules such as hybrid memory cube (HMC) modules. For example, the memory module 20 may be a semiconductor-based storage such as a solid state drive (SSD), DRAM, static random access memory (SRAM), phase-change random access memory (PRAM), resistive random access memory (RRAM), conductive-bridging RAM (CBRAM), magnetic RAM (MRAM), and spin-transfer torque MRAM (STT-MRAM).

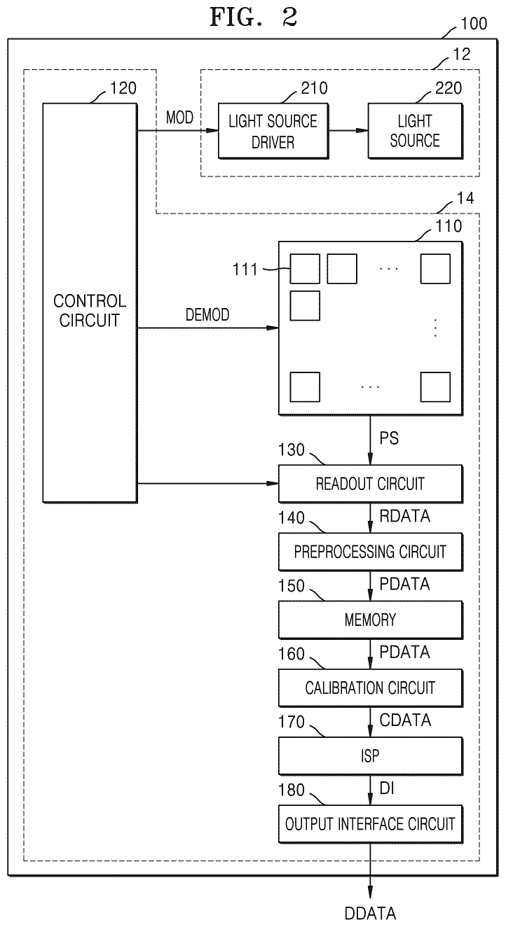

FIG. 2 is a configuration diagram illustrating the camera module 100 according to some example embodiments.

Referring to FIGS. 1 and 2, the camera module 100 may include the light source unit 12 and the image sensor 14 configured to measure distances. The camera module 100 may be used to acquire depth data DDATA including depth information DI on the object 200. In some example embodiments, the depth data DDATA may be used by the processor 30 as part of a 3D user interface to allow a user of the system 10 to interact with or use 3D images of the object 200 in a part of a game or an application running on the system 10.

The light source unit 12 may include a light source driver 210 and a light source 220. The light source unit 12 may further include a lens and a diffuser configured to diffuse light generated by the light source 220.

The light source 220 may transmit an optical transmission signal TX to the object 200. The light source 220 may include a laser diode (LD) or a light-emitting diode (LED) configured to emit infrared or visible light, a near infrared laser (NIR), a point light source, a white lamp, a monochromatic light source having a combination of monochromators, or a combination of other laser light sources. For example, the light source 220 may include a vertical-cavity surface-emitting laser (VCSEL). In some example embodiments, the light source 220 may output an infrared optical transmission signal TX having a wavelength of about 800 nm to about 1000 nm.

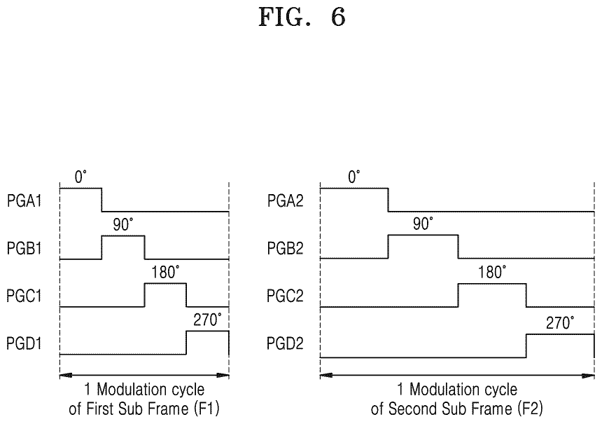

The light source driver 210 may generate a driving signal for driving the light source 220. The light source driver 210 may drive the light source 220 in response to a modulation signal MOD received from a control circuit 120. In this case, the modulation signal MOD may have at least one designated modulation frequency. The modulation frequency may have at least one value. For example, the control circuit 120 may generate a modulation signal MOD having a first modulation frequency F1 (for example, refer to FIG. 6) in a specific sub-frame, and a modulation signal MOD having a second modulation frequency F2 (for example, refer to FIG. 6) in another sub-frame.

The image sensor 14 may receive an optical reception signal RX reflected from the object 200. The image sensor 14 may measure a distance or depth based on a ToF.

The image sensor 14 may include a pixel array 110, the control circuit 120, a readout circuit 130, a preprocessing circuit 140, a memory 150, a calibration circuit 160, an image signal processor (ISP) 170, and an output interface circuit 180. The image sensor 14 may further include a lens, and an optical reception signal RX may be provided to the pixel array 110 through the lens. In addition, the image sensor 14 may further include a ramp signal generator configured to provide a ramp signal to the readout circuit 130; and an ambient light detector (ALD) (not shown) configured to calculate an ambient light environment and determine whether to start a binning mode.

The pixel array 110 may include a plurality of unit pixels 111. The plurality of unit pixels 111 may operate based on a ToF method. The structure of each of the plurality of unit pixels 111 are described below with reference to FIGS. 3A and 3B.

The pixel array 110 may convert an optical reception signal RX into corresponding electrical signals, that is, a plurality of pixel signals PS. The pixel array 110 may generate a plurality of pixel signals PS according to control signals received from the control circuit 120. For example, the pixel array 110 may generate the plurality of pixel signals PS according to a control signal having a first modulation frequency F1 in a first sub-frame, and may generate the plurality of pixel signals PS according to a control signal having a second modulation frequency F2 in a second sub-frame. The pixel array 110 may receive a plurality of demodulation signals DEMOD from the control circuit 120 as photogate signals that are respectively for controlling transfer transistors of the unit pixels 111. The plurality of pixel signals PS may include information on a phase difference between an optical transmission signal TX and an optical reception signal RX.

The plurality of demodulation signals DEMOD may have the same frequency as the modulation signal MOD, that is, the plurality of demodulation signals DEMOD, may have the same frequency as the modulation frequency. The demodulation signals DEMOD may include first to fourth photogate signals PGA to PGD (for example, refer to FIG. 3A) that are out of phase with each other by 90°. For example, the first photogate signal PGA may have a phase shift of 0°, the second photogate signal PGB may have a phase shift of 90°, the third photogate signal PGC may have a phase shift of 180°, and the fourth photogate signal PGD may have a phase shift of 270°. This is, the first to fourth photogate signals PGA-PGD may be separated by 90°. In some example embodiments, there may be fewer or greater numbers of photogate signals, and the offset may be equidistant or variable without departing from the inventive concepts. The plurality of pixel signals PS output from the pixel array 110 may include a first pixel signal Vout1 (for example, refer to FIG. 3A) generated according to the first photogate signal PGA; a second pixel signal Vout2 (for example, refer to FIG. 3A) generated according to the second photogate signal PGB; a third pixel signal Vout3 (for example, refer to FIG. 3A) generated according to the third photogate signal PGC, and a fourth pixel signal Vout4 (for example, refer to FIG. 3A) generated according to the fourth photogate signal PGD.

The readout circuit 130 may generate raw data RDATA based on the plurality of pixel signals PS output from the pixel array 110. For example, the readout circuit 130 may read out the plurality of pixel signals PS from the pixel array 110 in units of sub-frames. The readout circuit 130 may generate raw data RDATA by performing analog-digital conversion on each of the plurality of pixel signals PS. For example, the readout circuit 130 may include a correlated double sampling (CDS) circuit, a column counter, and a decoder. The readout circuit 130 may perform a CDS operation by comparing the plurality of pixel signals PS with a ramp signal.

The control circuit 120 may control components of the image sensor 14, and the light source driver 210 of the light source unit 12. The control circuit 120 may transmit a modulation signal MOD to the light source driver 210, and may transmit a plurality of demodulation signals DEMOD corresponding to the modulation signal MOD to the pixel array 110. The control circuit 120 may include a photogate driver configured to provide a plurality of demodulation signals DEMOD as photogate signals to the pixel array 110; a row driver and a decoder that are configured to provide row control signals to the pixel array 110; a phase locked loop (PLL) circuit configured to generate an internal clock signal from a master clock signal; a timing generator configured to adjust the timing of each control signal; a transmission circuit configured to transmit a modulation signal MOD; and a main controller configured to control operations of the image sensor 14 according to commands received from the outside of the camera module 100.

In some example embodiments, the control circuit 120 may perform a shuffle operation to change the phases of photogate signals provided to photogate transistors (for example, refer to TS1 to TS4 in FIG. 3A) of the unit pixels 111 according to sub-frames. A mismatch between taps of the unit pixels 111 or a mismatch between the unit pixels 111 and the readout circuit 130 may be compensated for through the shuffle operation.

In some example embodiments, the control circuit 120 may operate in a binning mode based on an ambient light environment sensed by the ALD. For example, the control circuit 120 may operate in the binning mode in a low-light environment. The control circuit 120 may operate in an analog binning mode in which the pixel array 110 and the readout circuit 130 are controlled to obtain one signal by adding up in-phase pixel signals among pixel signals output from a plurality of unit pixels 111, for example, four unit pixels 111, and then to analog-digital convert the obtained signal. The analog binning mode may have an effect of substantially increasing responsiveness to light.

Alternatively, the control circuit 120 may operate in a digital binning mode to analog-digital convert pixel signals output from a plurality of unit pixels 111, for example, four unit pixels 111, and then to add up in-phase data. The digital binning mode may have an effect of substantially increasing full well capacity (FWC).

The preprocessing circuit 140 may preprocess the raw data RDATA such that the ISP 170 may easily operate. The preprocessing circuit 140 may generate phase data PDATA by converting the raw data RDATA into a form facilitating conversion into depth information, or by compressing the raw data RDATA.

For example, the preprocessing circuit 140 may calculate a value I by subtracting raw data generated according to the third photogate signal PGC having a phase shift of 180° from raw data generated according to the first photogate signal PGA having a phase shift of 0°. In addition, for example, the preprocessing circuit 140 may calculate a value Q by subtracting raw data generated according to the fourth photogate signal PGD having a phase shift of 270° from raw data generated according to the second photogate signal PGB having a phase shift of 90°.

Phase data preprocessed by the preprocessing circuit 140 may be stored in the memory 150. For example, the memory 150 may be implemented as a buffer. The memory 150 may include a frame memory, and phase data generated on a sub-frame basis through an exposure integration operation and a readout operation may be stored in the memory 150. For example, phase data PDATA generated in each of a plurality of sub-frames according to a shuffle operation or a modulation frequency change may be stored in the memory 150.

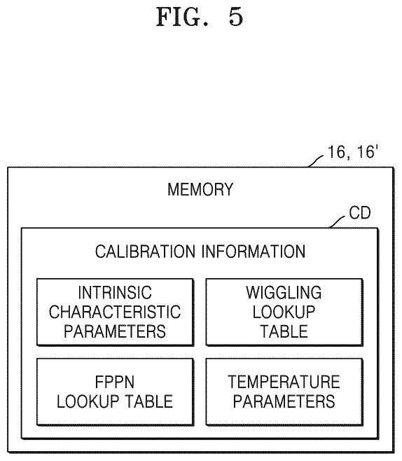

The calibration circuit 160 may perform a calibration operation to improve the accuracy of depth information DI to be generated in the ISP 170. The calibration circuit 160 may generate correction data CDATA by performing a calibration operation on phase data PDATA based on calibration information CD (for example, refer to FIG. 5). For example, the calibration circuit 160 may perform operations such as a calibration operation by considering factors such as the physical characteristics of the image sensor 14 or the physical characteristics of lenses included in the camera module 100, a calibration operation by considering the distance between the light source unit 12 and the image sensor 14, or a calibration operation by considering nonlinear filter errors caused by square-wave demodulation signals DEMOD.

Although FIG. 2 shows that the calibration circuit 160 performs a calibration operation on phase data PDATA stored in the memory 150, the image sensor 14 of the inventive concepts are not limited thereto. The calibration circuit 160 may receive phase data PDATA from the preprocessing circuit 140, and correction data CDATA generated as a result of a calibration operation may be stored in the memory 150.

The ISP 170 may receive correction data CDATA from the calibration circuit 160 and generate depth information DI. However, in some example embodiments, the ISP 170 may receive phase data PDATA from the memory 150, and the operation of the calibration circuit 160 may be performed by the ISP 170.

In some example embodiments, the ISP 170 may be implemented as an embedded depth processor unit (eDPU), and the eDPU may generate depth information DI by performing an operation such as phase delay calculation, lens correction, spatial filtering, temporal filtering, or data unfolding. The eDPU may be configured to perform simple mathematical operations using hard-wired logic, but is not limited thereto. The calibration circuit 160 may also be implemented as an eDPU. The eDPU may perform a shuffle operation and a correction operation according to a demodulation frequency change.

The ISP 170 may generate depth information DI corresponding to a depth frame by using correction data CDATA generated in each of a plurality of sub-frames. Once data compression is performed by the preprocessing circuit 140, the ISP 170 may perform a decompression operation to decompress the correction data CDATA.

The correction data CDATA may include information on a phase difference between an optical transmission signal TX and an optical reception signal RX. The ISP 170 may calculate the distance between the object 200 and the camera module 100 by using information on the phase difference and may generate depth information DI. For example, as described above, when the preprocessing circuit 140 performs a preprocessing operation to calculate a value I and a value Q, a phase difference between an optical transmission signal TX and an optical reception signal RX may be calculated by using the value I and the value Q (for example, by calculating an inverse trigonometric function (e.g., arctangent) of the ratio of the value Q to the value I), and the distance between the object 200 and the camera module 100 may be calculated from the phase difference. Alternatively, for example, the ISP 170 may calculate a value I and a value Q, a phase difference between an optical transmission signal TX and an optical reception signal RX by using the value I and the value Q, and the distance between the object 200 and the camera module 100 by using the phase difference.

In some example embodiments, the ISP 170 may perform a crossover operation using a multi-frequency modulation signal MOD having a first modulation frequency F1 and a second modulation frequency F2, and correction data CDATA generated according to multi-frequency demodulation signals DEMOD, thereby preventing or reducing a repeated distance phenomenon referring to an error in depth information DI caused by a maximum measurement distance limit, and making it possible to obtain depth information without being limited by the maximum measurement distance. Furthermore, in some example embodiments, the ISP 170 may use correction data CDATA generated through a shuffle operation for each of first and second sub-frames to compensate for noise which is caused by a process-originated mismatch between the taps of the unit pixels 111 or a process-originated mismatch between the unit pixels 111 and the readout circuit 130.

The output interface circuit 180 may generate depth data DDATA in units of depth frames by formatting depth information DI received from the ISP 170 and may output the depth data DDATA to the outside of the camera module 100 through a channel. Because the image sensor 14 for distance measurement of the inventive concepts includes the memory 150 and the ISP 170 therein, the image sensor 14 may calculate phase differences and generate depth data DDATA including depth information DI. Therefore, because the image sensor 14 transmits depth data DDATA to the processor 30 outside the camera module 100, data transmission delay may be prevented or reduced even when the bandwidth of a channel between the image sensor 14 and the processor 30 is limited, thereby increasing the quality of depth data DDATA.

In addition, the calibration circuit 160 of the image sensor 14 may reduce noise that may occur in depth data DDATA, and the ISP 170 included in the image sensor 14 may make it possible to generate high-quality depth data DDATA. The processor 30 provided outside the image sensor 14 may be lightweight, and the power consumption of the system 10 may be reduced.

FIG. 3A is a diagram illustrating an example structure of the unit pixels 111 shown in FIG. 2, according to some example embodiments.

A unit pixel 111 shown in FIG. 3A may have a 4-tap structure. The 4-tap structure refers to a structure in which one unit pixel 111 includes four taps, and the four taps may be unit components configured such that when the unit pixel 111 generates and accumulates photocharge in response to an external optical signal applied thereto, the unit components may transfer the photocharge distinguishably according to phases.

An image sensor (for example, the image sensor 14 shown in FIG. 2) including the unit pixel 111 having a 4-tap structure may implement a transmission method in which data is transmitted using four taps with phase shifts of 0°, 90°, 180°, and 270°. For example, the unit pixel 111 may generate pixel signals based on a first tap of the unit pixel 111. Specifically, when the first tap of the unit pixel 111 generates a first pixel signal Vout1 with respect to a phase shift of 0°, a second tap of the unit pixel 111 may generate a second pixel signal Vout2 with respect to a phase shift of 90°, a third tap of the unit pixel 111 may generate a third pixel signal Vout3 with respect to a phase shift of 180°, and a fourth tap of the unit pixel 111 may generate a fourth pixel signal Vout4 with respect to a phase shift of 270°.

The pixel array 110 (for example, refer to FIG. 2) may include a plurality of unit pixels 111 arranged in a plurality of rows and a plurality of columns. In some example embodiments, the first tap and the fourth tap of each of the unit pixels 111 may be disposed in an ith row, and the second tap and the third tap each of the unit pixels 111 may be disposed in an (i+1)th row.

Referring to FIG. 3A, the unit pixel 111 may include a photodiode PD, an overflow transistor OT, first to fourth transfer transistors TS1 to TS4, first to fourth storage transistors SS1 to SS4, first to fourth tap transfer transistors TXS1 to TXS4, first to fourth reset transistors RX1 to RX4, first to fourth source followers SF1 to SF4, and first to fourth selection transistors SELX1 to SELX4. In some example embodiments, at least one selected from the group consisting of the overflow transistor OT, the first to fourth storage transistors SS1 to SS4, the first to fourth tap transfer transistors TXS1 to TXS4, the first to fourth reset transistors RX1 to RX4, the first to fourth source followers SF1 to SF4, and the first to fourth selection transistors SELX1 to SELX4 may be omitted. Furthermore, in some example embodiments, the unit pixel 111 may further include a transistor disposed between a transfer transistor (one of the first to fourth transfer transistors TS1 to TS4) and a storage transistor (one of the first to fourth storage transistors SS1 to SS4).

The photodiode PD may generate photocharge that varies according to the intensity of an optical reception signal (for example, refer to RX in FIG. 2). That is, the photodiode PD may convert an optical reception signal RX into an electrical signal. The photodiode PD is an example of a photoelectric conversion element and may be one of a phototransistor, a photogate, a pinned photodiode (PPD), and a combination thereof.

The first to fourth transfer transistors TS1 to TS4 may transfer electric charge generated in the photodiode PD to the first to fourth storage transistors SS1 to SS4, respectively, according to first to fourth photogate signals PGA to PGD. Therefore, the first to fourth transfer transistors TS1 to TS4 may transfer charge generated in the photodiode PD to first to fourth floating diffusion nodes FD1 to FD4, respectively, according to the first to fourth photogate signals PGA to PGD.

The first to fourth photogate signals PGA to PGD may be included in the demodulation signals DEMOD described with reference to FIG. 2, and may be signals that have the same frequency and duty ratio and are out of phase with each other. The first to fourth photogate signals PGA to PGD may have a phase difference of 90° from each other. For example, based on the first photogate signal PGA, when the first photogate signal PGA has a phase shift of 0°, the second photogate signal PGB may have a phase shift of 90°, the third photogate signal PGC may have a phase shift of 180°, and the fourth photogate signal PGD may have a phase shift of 270°.

According to first to fourth storage control signals SGA to SGD, the first to fourth storage transistors SS1 to SS4 may store photocharges received respectively from the first to fourth transfer transistors TS1 to TS4. According to a first transmission control signal TG[i] and a second transmission control signal TG[i+1], the first to fourth tap transfer transistors TXS1 to TXS4 may transfer photocharges respectively stored in the first to fourth storage transistors SS1 to SS4 to the first to fourth floating diffusion nodes FD1 to FD4.

According to the potentials of photocharges accumulated in the first to fourth floating diffusion nodes FD1 to FD4, the first to fourth source followers SF1 to SF4 may amplify corresponding photocharges and output the amplified corresponding photocharges to the first to fourth selection transistors SELX1 to SELX4. The first to fourth selection transistors SELX1 to SELX4 may output first to fourth pixel signals Vout1 to Vout4 through column lines in response to a first selection control signal SEL[i] and a second selection control signal SEL[i+1].

The unit pixel 111 may accumulate photocharge for a certain period of time, for example, an integration period of time, and may output first to fourth pixel signals Vout1 to Vout4 generated according to results of the accumulation to the readout circuit 130 (for example, refer to FIG. 2).

The first to fourth reset transistors RX1 to RX4 may reset the first to fourth floating diffusion nodes FD1 to FD4 to a power supply voltage VDD in response to a first reset control signal RS[i] and a second reset control signal RS[i+1]. The overflow transistor OT is a transistor configured to discharge overflow charge according to an overflow control signal OG. A source of the overflow transistor OT may be connected to the photodiode PD, and the power supply voltage VDD may be provided to a drain of the overflow transistor OT.

FIG. 3B is a diagram illustrating an example structure of the unit pixels 111 shown in FIG. 2, according to some example embodiments.

A unit pixel 111A illustrated in FIG. 3B may have a 2-tap structure. The 2-tap structure refers to a structure in which one unit pixel 111A includes two taps, and the two taps may be unit components configured such that when the unit pixel 111A generates and accumulates photocharge in response to an external optical signal applied thereto, the unit components may transfer the photocharge distinguishably according to phases.

An image sensor (for example, the image sensor 14 shown in FIG. 2) including the unit pixel 111A having a 2-tap structure may implement a transmission method in which data is transmitted using two taps with phase shifts of 0°, 90°, 180°, and 270°. For example, when a first tap of the unit pixel 111A generates a first pixel signal Vout1 with respect to a phase shift of 0° in an even sub-frame, a second tap may generate a second pixel signal Vout2 with respect to a phase shift of 180° in the even sub-frame. When the first tap of the unit pixel 111A generates a first pixel signal Vout1 with respect to a phase shift of 90° in an odd sub-frame, the second tap of the unit pixel 111A may generate a second pixel signal Vout2 with respect to a phase shift of 270° in the odd sub-frame

The pixel array 110 (for example, refer to FIG. 2) may include a plurality of unit pixels 111A arranged in a plurality of rows and a plurality of columns. In some example embodiments, the first tap and the second tap of each of the unit pixels 111A may be arranged in an ith row.

Referring to FIG. 3B, the unit pixel 111A may include a photodiode PD, an overflow transistor OT, first and second transfer transistors TS1 and TS2, first and second storage transistors SS1 and SS2, first and second tap transfer transistors TXS1 and TXS2, first and second reset transistors RX1 and RX2, first and second source followers SF1 and SF2, and first and second selection transistors SELX1 and SELX2. In some example embodiments, at least one selected from the group consisting of the overflow transistor OT, the first and second storage transistors SS1 and SS2, the first and second tap transfer transistors TXS1 and TXS2, the first and second reset transistors RX1 and RX2, the first and second source followers SF1 and SF2, and the first and second selection transistors SELX1 and SELX2 may be omitted. Furthermore, in some example embodiments, the unit pixel 111A may further include a transistor disposed between a transfer transistor (one of the first and second transfer transistors TS1 and TS2) and a storage transistor (one of the first and second storage transistors SS1 and SS2).

In an even (e.g., 2nd, 4th, 6th, etc.) sub-frame, the first transfer transistor TS1 may transfer charge generated in the photodiode PD to the first storage transistor SS1 according to a first photogate signal PGA, and in an odd (e.g., 1st, 3rd, 5th, etc.) sub-frame, the first transfer transistor TS1 may transfer charge generated in the photodiode PD to the first storage transistor SS1 according to a second photogate signal PGB. In the even sub-frame, the second transfer transistor TS2 may transfer charge generated in the photodiode PD to the second storage transistor SS2 according to a third photogate signal PGC, and in the odd sub-frame, the second transfer transistor TS2 may transfer charge generated in the photodiode PD to the second storage transistor SS2 according to a fourth photogate signal PGD. The first to fourth photogate signals PGA to PGD may be included in the demodulation signals DEMOD described with reference to FIG. 2, and may be signals that have the same frequency and duty ratio and are out of phase with each other. The first to fourth photogate signals PGA to PGD may have a phase difference of 90° from each other.

In an even sub-frame, the unit pixel 111A may accumulate photocharge for an integration time and may output a first pixel signal Vout1 and a second pixel signal Vout2 generated according to results of the accumulation to the readout circuit 130 (for example, refer to FIG. 2). Furthermore, in an odd sub-frame, the unit pixel 111A may accumulate photocharge for an integration time and may output a first pixel signal Vout1 and a second pixel signal Vout2 generated according to results of the accumulation to the readout circuit 130.

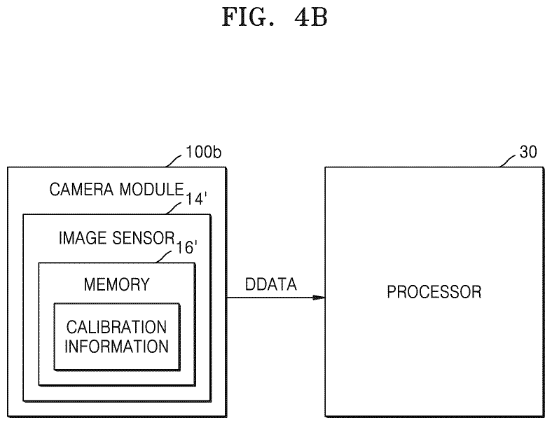

FIGS. 4A and 4B are block diagrams illustrating schematic configurations of systems according to some example embodiments. FIG. 5 is a diagram illustrating calibration information stored in memories 16 and 16′. According to the inventive concepts, camera modules 100a and 100b may store, in internal memories, calibration information to be used for calibration. However, the inventive concepts are not limited to the example embodiments shown in FIGS. 4A and 4B, and the camera modules 100a and 100b may receive calibration information from the outside of the camera modules 100a and 100b (for example, from the processor 30).

Referring to FIG. 4A, the camera module 100a may further include a memory 16 to store calibration information CD. An image sensor 14 may receive the calibration information CD from the memory 16. The image sensor 14 may perform a calibration operation based on the calibration information CD received from the memory 16 provided outside the image sensor 14.

Referring to FIG. 4B, the camera module 100b may include an image sensor 14′ including a memory 16′. The memory 16′ may store calibration information CD and may be different from the memory 150 shown in FIG. 2. A calibration circuit (for example, refer to the calibration circuit 160) of the image sensor 14′ may perform a calibration operation based on the calibration information CD received from the memory 16′ provided inside the image sensor 14′.

In some example embodiments, the memories 16 and 16′ may be one-time programmable (OTP) memories or electrically erasable programmable read-only memories (EEPROMs). However, the memories 16 and 16′ are not limited thereto, and various other types of memories may be used as the memories 16 and 16′.

Referring to FIGS. 2 and 5, for example, calibration information CD stored in the memories 16 and 16′ may include at least one selected from the group consisting of intrinsic characteristic parameters, a wiggling lookup table, a fixed phase pattern noise (FPPN) lookup table, and temperature parameters. The temperature parameters may be calibration parameters related to temperature environments in which the camera module 100 may operate (for example, related to external environment temperatures).

The intrinsic characteristic parameters may be calibration parameters related to intrinsic physical characteristics of the camera module 100. That is, the intrinsic characteristic parameters may be calibration parameters related to physical characteristics of the image sensor 14 and the light source unit 12. For example, the intrinsic characteristic parameters may include parameters for correcting errors caused by aberration of lenses that are included in the camera module 100 to transmit and receive optical transmission signals TX and optical reception signals RX; or parameters for correcting errors that are caused by movement/tilting of lenses when the lenses are assembled to the camera module 100.

The wiggling lookup table may include a lookup table for correcting a wiggling effect. The wiggling effect may refer to an error caused by harmonic components that are generated according to the waveform of an optical transmission signal output from the light source unit 12 and the waveforms of demodulation signals DEMOD. Here, an error caused by the wiggling effect may vary depending on the distance between an object and a camera module, and the wiggling lookup table may include information about the degree of correction according to the distance between an object and a camera module.

The FPPN lookup table may be used to correct an error caused by FPPN. FPPN may occur due to a misalignment between the light source unit 12 and the image sensor 14. For example, the FPPN lookup table may include information about the degree of correction according to positions as information for correcting phase deviations occurring according to the positions of the unit pixels 111 in the pixel array 110. For example, a calibration operation may be performed using the FPPN lookup table for errors occurring according to the distance between the light source unit 12 and the image sensor 14, or errors caused by a time delay occurring when control signals are provided from the control circuit 120 to the pixel array 110.

FIG. 6 is a diagram illustrating an operation of the image sensor 14 according to the inventive concepts with timing charts showing frequencies of first to fourth photogate signals.

Referring to FIGS. 2 and 6, the control circuit 120 may generate first to fourth photogate signals PGA1 to PGD1 having a first modulation frequency F1 in a first sub-frame. In addition, the control circuit 120 may generate first to fourth photogate signals PGA2 to PGD2 having a second modulation frequency F2 in a second sub-frame. The first modulation frequency F1 and the second modulation frequency F2 may be different from each other. For example, the first modulation frequency F1 may be set to be 20 MHz, and the second modulation frequency F2 may be set to be 10 MHz. Alternatively, for example, the first modulation frequency F1 may be set to be 100 MHz, and the second modulation frequency F2 may be set to be 30 MHz.

The maximum measurement distance that may be measured using the image sensor 14 may be inversely proportional to modulation frequencies. For example, when the first modulation frequency F1 is 20 MHz, the maximum measurement distance may be 7.5 m, and when the second modulation frequency F2 is 10 MHz, the maximum measurement distance may be 15 m. Therefore, because the ISP 170 varies modulation frequencies and generates depth information DI through a crossover operation (greatest common divisor operation) based on pixel signals PS generated in a first sub-frame and pixel signals PS generated in a second sub-frame, a repeated distance phenomenon referring to an error in depth information DI caused by a maximum measurement distance limit may be prevented or reduced, and depth information DI may be obtained without being limited by the maximum measurement distance.

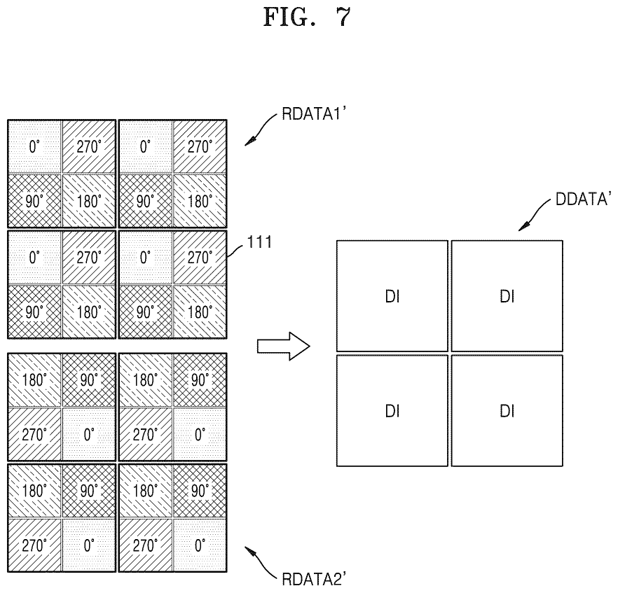

FIG. 7 is a diagram illustrating a shuffle operation of the image sensor 14 according to the inventive concepts. FIG. 7 illustrates an example in which a unit pixel 111 of the image sensor 14 has a 4-tap structure described with reference to FIG. 3A.

Referring to FIGS. 2, 3A, and 7, in a first sub-frame, the image sensor 14 may provide a first photogate signal PGA having a phase shift of 0° to the first transfer transistor TS1 of the first tap of the unit pixel 111, a second photogate signal PGB having a phase shift of 90° to the second transfer transistor TS2 of the second tap of the unit pixel 111, a third photogate signal PGC having a phase shift of 180° to the third transfer transistor TS3 of the third tap of the unit pixel 111, and a fourth photogate signal PGD having a phase shift of 270° to the fourth transfer transistor TS4 of the fourth tap of the unit pixel 111. Therefore, based on the first tap of the unit pixel 111, when the first tap of the unit pixel 111 generates a first pixel signal Vout1 with respect to a phase shift of 0°, the second tap of the unit pixel 111 may generate a second pixel signal Vout2 with respect to a phase shift of 90°, the third tap of the unit pixel 111 may generate a third pixel signal Vout3 with respect to a phase shift of 180°, and the fourth tap of the unit pixel 111 may generate a fourth pixel signal Vout4 with respect to a phase shift of 270°. In the first sub-frame, a first piece of raw data RDATA1′ may be generated from the first to fourth pixel signals Vout1 to Vout4 generated respectively according to the first to fourth photogate signals PGA to PGD having four different phase shifts (0°, 90°, 180°, and 270°).

In a second sub-frame following the first sub-frame, the image sensor 14 may perform a shuffle operation. In the second sub-frame, the image sensor 14 may provide a third photogate signal PGC having a phase shift of 180° to the first transfer transistor TS1 of the first tap of the unit pixel 111, a fourth photogate signal PGD having a phase shift of 270° to the second transfer transistor TS2 of the second tap of the unit pixel 111, a first photogate signal PGA having a phase shift of 0° to the third transfer transistor TS3 of the third tap of the unit pixel 111, and a second photogate signal PGB having a phase shift of 90° to the fourth transfer transistor TS4 of the fourth tap of the unit pixel 111. Therefore, based on the first tap of the unit pixel 111, when the first tap of the unit pixel 111 generates a first pixel signal Vout1 with respect to a phase shift of 180°, the second tap of the unit pixel 111 may generate a second pixel signal Vout2 with respect to a phase shift of 270°, the third tap of the unit pixel 111 may generate a third pixel signal Vout3 with respect to a phase shift of 0°, and the fourth tap of the unit pixel 111 may generate a fourth pixel signal Vout4 with respect to a phase shift of 90°. In the second sub-frame, a second piece of raw data RDATA2′ may be generated from the first to fourth pixel signals Vout1 to Vout4 generated respectively according to the first to fourth photogate signals PGA to PGD having four different phase shifts (180°, 270°, 0°, and 90°).

The ISP 170 may generate depth information DI using the first piece of raw data RDATA1′ and the second piece of raw data RDATA2′. Although the ISP 170 may generate pieces of depth information DI respectively from the first piece of raw data RDATA1′ and the second piece of raw data RDATA2′, the ISP 170 may generate one piece of depth data DDATA′ (including pieces of depth information DI) using the first piece of raw data RDATA1′ and the second piece of raw data RDATA2′ to compensate for a mismatch between the first to fourth taps of the unit pixel 111 or a mismatch between the unit pixel 111 and the readout circuit 130 that may occur during processes. For example, the ISP 170 may average the first piece of raw data RDATA1′ and the second piece of raw data RDATA2′ generated through the shuffle operation and may remove errors such as a gain error of each of the first to fourth taps, an error caused by a conversion gain difference between the first to fourth floating diffusion nodes FD1 to FD4 of the first to fourth taps, an offset error of each of the first to fourth taps, and an error caused by an offset difference between the first to fourth taps.

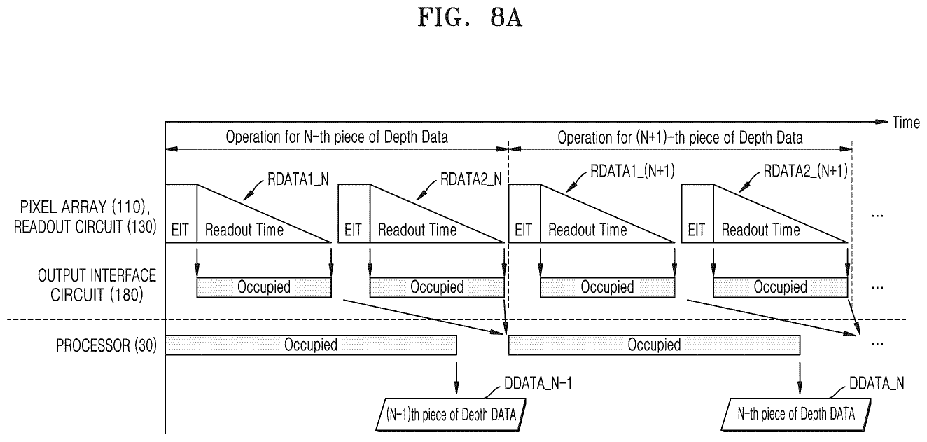

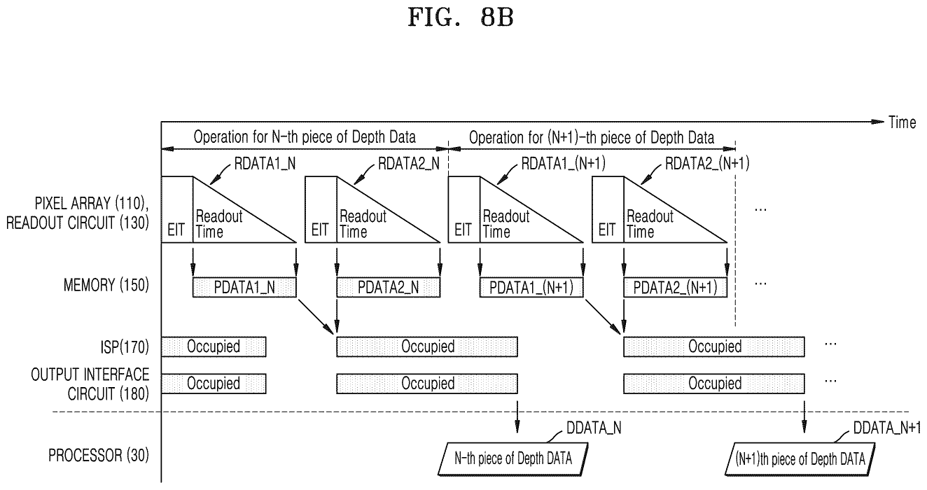

FIG. 8A is a timing diagram illustrating an operation of an image sensor according to a comparative example, and FIG. 8B is a diagram illustrating an operation of the image sensor 14 according to the inventive concepts.

Referring to FIG. 8A, the image sensor of the comparative example does not include an ISP therein. In the image sensor of the comparative example, a pixel array 110 may store phase information during an exposure integration time EIT, and a readout circuit 130 may generate raw data during a readout time. For example, in a first sub-frame, the image sensor of the comparative example may generate a first piece of raw data RDATA1_N (N is a natural number) according to a first modulation frequency F1 (for example, refer to FIG. 6), and in a second sub-frame, the image sensor of the comparative example may generate a second piece of raw data RDATA2_N according to a second modulation frequency F2 (for example, refer to FIG. 6). An output interface circuit 180 of the image sensor of the comparison example may sequentially transmit the first piece of raw data RDATA1_N and the second piece of raw data RDATA2_N including phase information to a processor 30 provided outside the image sensor of the comparative example. The processor 30 may include an ISP.

While the image sensor of the comparative example performs an operation for an Nth piece of depth data DDATA_N, the processor 30 provided outside the image sensor of the comparative example may perform an operation of generating an (N−1)th piece of depth data DDATA_N−1. After receiving both the first piece of raw data RDATA1_N and the second piece of raw data RDATA2_N including phase information from the image sensor of the comparison example, the processor 30 may generate an Nth piece of depth data DDATA_N using the first piece of raw data RDATA1_N and the second piece of raw data RDATA2_N. While the processor 30 generates the Nth piece of depth data DDATA_N, the image sensor of the comparative example may perform an operation for an (N+1)th piece of depth data DDATA_(N+1). For example, in a first sub-frame, the image sensor of the comparative example may generate a first piece of raw data RDATA1_(N+1) according to a first modulation frequency F1, and in a second sub-frame, the image sensor of the comparative example may generate a second piece of raw data RDATA2_(N+1) according to a second modulation frequency F2.

Although the image sensor of the comparative example has to transmit all pieces of raw data (for example, the first and second pieces of raw data RDATA1_N and RDATA2_N) including phase information to the processor 30, the bandwidth of a channel between the image sensor and the processor 30 is limited, and thus, it may take a long time to transmit the first and second pieces of raw data RDATA1_N and RDATA2_N. In addition, even after the image sensor of the comparison example transmits the first and second pieces of raw data RDATA1_N and RDATA2_N, it takes time for the processor 30 to generate the Nth piece of depth data DDATA_N using the first and second pieces of raw data RDATA1_N and RDATA2_N. Thus, there is a time delay until the Nth piece of depth data DDATA_N is generated after the pixel array 110 and the readout circuit 130 generate the first and second pieces of raw data RDATA1_N and RDATA2_N.

Referring to FIGS. 2 and 8B, the image sensor 14 of the inventive concepts may include the memory 150 and the ISP 170. The pixel array 110 and the readout circuit 130 of the image sensor 14 may store phase information during an exposure integration time EIT and may generate raw data during a readout time. For example, in a first sub-frame, the image sensor 14 may generate a first piece of raw data RDATA1_N according to a first modulation frequency F1, and in a second sub-frame, the image sensor 14 may generate a second piece of raw data RDATA2_N according to a second modulation frequency F2, to generate an Nth piece of depth data DDATA_N. Alternatively, for example, in the first and second sub-frames, the image sensor 14 of the inventive concepts may perform a shuffle operation as described with reference to FIG. 7 to vary the phases of demodulation signals DEMOD to be supplied to the unit pixels 111, thereby generating a first piece of raw data RDATA1_N and a second piece of raw data RDATA2_N to generate an Nth piece of depth data DDATA_N.

The memory 150 may store a first piece of phase data PDATA1_N obtained by preprocessing the first piece of raw data RDATA1_N, and may then store a second piece of phase data PDATA2_N obtained by preprocessing the second piece of raw data RDATA2_N. The ISP 170 may generate an Nth piece of depth information using the first piece of raw data RDATA1_N and the second piece of raw data RDATA2_N stored in the memory 150, and the output interface circuit 180 may format the Nth piece of depth information and may then transmit the Nth piece of depth information as a Nth piece of depth data DDATA_N to the processor 30.

Furthermore, in a first sub-frame, the image sensor 14 may generate a first piece of raw data RDATA1_(N+1) according to a first modulation frequency F1, and in a second sub-frame, the image sensor 14 may generate a second piece of raw data RDATA2_(N+1) according to a second modulation frequency F2, to generate an (N+1)th piece of depth data DDATA_N+1.

The memory 150 may store a first piece of phase data PDATA1_(N+1) obtained by preprocessing the first piece of raw data RDATA1_(N+1), and may then store a second piece of phase data PDATA2_(N+1) obtained by preprocessing the second piece of raw data RDATA2_(N+1). The ISP 170 may generate an (N+1)th piece of depth information using the first piece of raw data RDATA1_(N+1) and the second piece of raw data RDATA2_(N+1) that are stored in the memory 150, and the output interface circuit 180 may format the (N+1)th piece of depth information and may then transmit the (N+1)th piece of depth information as a (N+1)th piece of depth data DDATA_N+1 to the processor 30.

Because the image sensor 14 for distance measurement of the inventive concepts includes the memory 150 and the ISP 170 therein, the image sensor 14 may calculate phase differences and may generate depth data (for example, DDATA_N and DDATA_N+1). Because the image sensor 14 transmits depth data (for example, DDATA_N and DDATA_N+1) to the processor 30 provided outside the image sensor 14, data transmission delay may be prevented or reduced even when the bandwidth of a channel between the image sensor 14 and the processor 30 is limited, and thus, the quality of depth data (for example, DDATA_N and DDATA_N+1) may be increased. In addition, because the image sensor 14 includes the ISP 170 dedicated to the image sensor 14, the image sensor 14 may generate high-quality depth data DDATA, the processor 30 provided outside the image sensor 14 may be lightweight, and power consumption of the system 10 may be reduced.

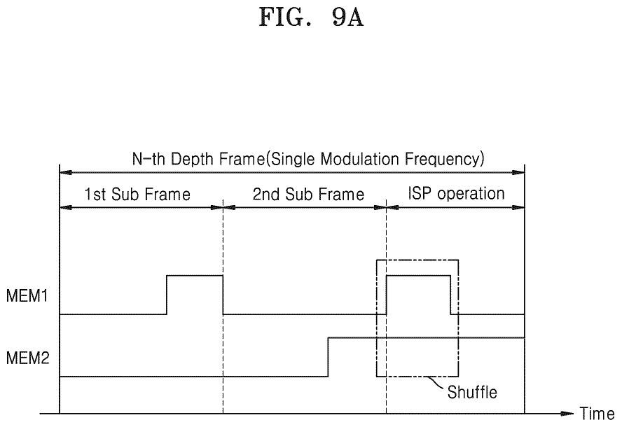

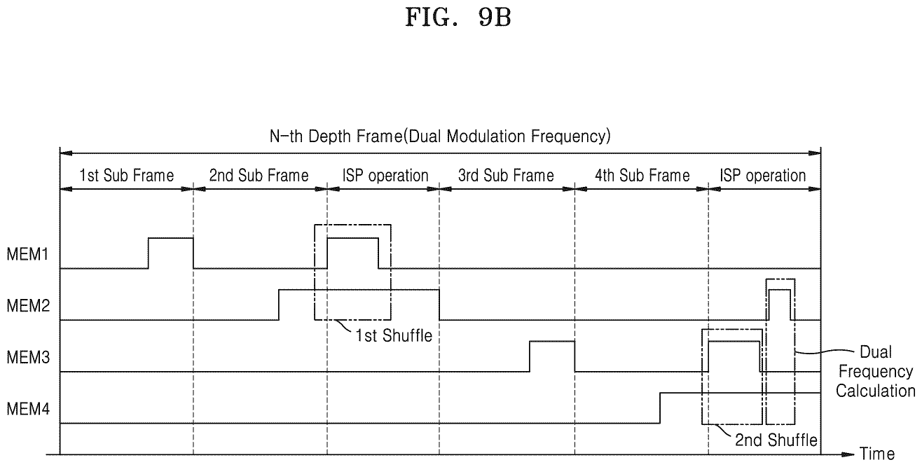

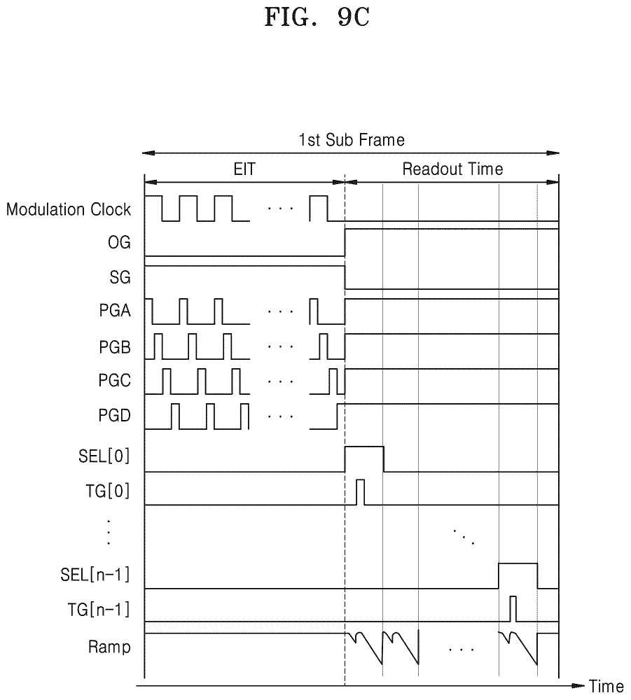

FIGS. 9A to 9C are diagrams illustrating operations of an image sensor according to the inventive concepts. FIG. 9A is a diagram illustrating an image sensor operating at a single modulation frequency and performing a shuffle operation, and FIG. 9B is a diagram illustrating an image sensor operating at dual modulation frequencies and performing a shuffle operation. FIG. 9C is a timing diagram illustrating signals generated in one sub-frame. Descriptions given with reference to FIGS. 9A to 9C may be applied to image sensors including unit pixels having a 4-tap structure, but may also be similarly applied to image sensors including unit pixels having a 2-tap structure.

Referring to FIGS. 2 and 9A, an Nth depth frame for generating an Nth piece of depth data may include a first sub-frame and a second sub-frame. As described with reference to FIG. 7, a first piece of raw data generated in the first sub-frame and a second piece of raw data generated in the second sub-frame may be data sampled through a shuffle operation by using photogate signals having different phases.

The first piece of raw data generated in the first sub-frame or a first piece of phase data obtained by preprocessing the first piece of raw data may be stored in a first memory MEM1. The second piece of raw data generated in the second sub-frame or a second piece of phase data obtained by preprocessing the second piece of raw data may be stored in a second memory MEM2. The first memory MEM1 and the second memory MEM2 may be included in the memory 150, and a high-level period may be a period in which a corresponding memory is activated, that is, a period in which data is written to or read from a corresponding memory.

The ISP 170 may perform a shuffle operation by using the first piece of phase data read from the first memory MEM1 and the second piece of phase data read from the second memory MEM2. Data from which errors are removed through the shuffle operation may be stored again in the second memory MEM2.

In some example embodiments, the first memory MEM1 and the second memory MEM2 may be frame memories. That is, the first memory MEM1 and the second memory MEM2 may store all phase data generated in one sub-frame. Alternatively, in some example embodiments for memory size optimization, a first piece of phase data obtained in a first sub-frame may be directly stored in the first memory MEM1 which is a frame memory, and a second piece of phase data obtained in a second sub-frame in which a shuffle operation is performed may be stored in a frame memory after the shuffle operation is performed using the second memory MEM2 which is a line memory and errors are removed from the second piece of phase data according to results of the shuffle operation.

Referring to FIGS. 2 and 9B, an Nth depth frame for generating an Nth piece of depth data may include first to fourth sub-frames. A first piece of phase data generated in the first sub-frame may be stored in a first memory MEM1, and a second piece of phase data generated in the second sub-frame may be stored in a second memory MEM2. A third piece of phase data generated in the third sub-frame may be stored in a third memory MEM3, and a fourth piece of phase data generated in the fourth sub-frame may be stored in a fourth memory MEM4. The first to fourth memories MEM1 to MEM4 may be included in the memory 150.

The first piece of phase data and the second piece of phase data may be data generated according to a first modulation frequency. The ISP 170 may perform a first shuffle operation using the first piece of phase data read from the first memory MEM1 and the second piece of phase data read from the second memory MEM2. A first piece of data from which errors are removed according to results of the first shuffle operation may be stored again in the second memory MEM2.

The third piece of phase data and the fourth piece of phase data may be data generated according to a second modulation frequency that is different from the first modulation frequency. The ISP 170 may perform a second shuffle operation using the third piece of phase data read from the third memory MEM3 and the fourth piece of phase data read from the fourth memory MEM4. A second piece of data from which errors are removed according to results of the second shuffle operation may be stored again in the fourth memory MEM4.

The ISP 170 may use the first piece of data generated according to the first shuffle operation and the second piece of data generated according to the second shuffle operation, to correct errors generated due to a maximum measurement distance limit. Error-corrected data may be stored again in the fourth memory MEM4.

Referring to FIGS. 3A and 9C, a first sub-frame may include an exposure integration time EIT and a readout time. The description of the first sub-frame shown in FIG. 9C may also be applied to other sub-frames.

During the exposure integration time EIT of the first sub-frame, a modulation clock may toggle with a constant period. First to fourth photogate signals PGA to PGD may have the same cycle as the modulation clock and may be toggled to have different phase shifts (0°, 90°, 180°, and) 270°.

An overflow control signal OG may maintain a logic low level, storage control signals SG (for example, SG1 to SG4) may maintain a logic high level, and selection control signals SEL[0] to SEL[n−1] and transfer control signals TG[0] to TG[n−1] may maintain a logic low level. Photocharges respectively transferred through the first to fourth transfer transistors TS1 to TS4 may be stored in the first to fourth storage transistors SS1 to SS4.

During the readout time following the exposure integration time EIT in the first sub-frame, the first to fourth photogate signals PGA to PGD may maintain a logic high level. The overflow control signal OG may maintain a logic high level, and the storage control signals SG (for example, SG1 to SG4) may maintain a logic low level. The selection control signals SEL[0] to SEL[n−1] and the transfer control signals TG[0] to TG[n−1] may transit to a logic high level such that first to nth rows may be sequentially turned on.

A ramp signal Ramp may be a signal for the readout circuit 130 (for example, refer to FIG. 2) to perform a CDS operation, and the readout circuit 130 may generate raw data by comparing first to fourth pixel signals Vout1 to Vout4 with the ramp signal Ramp. For example, the ramp signal Ramp may decrease or increase with a constant slope.

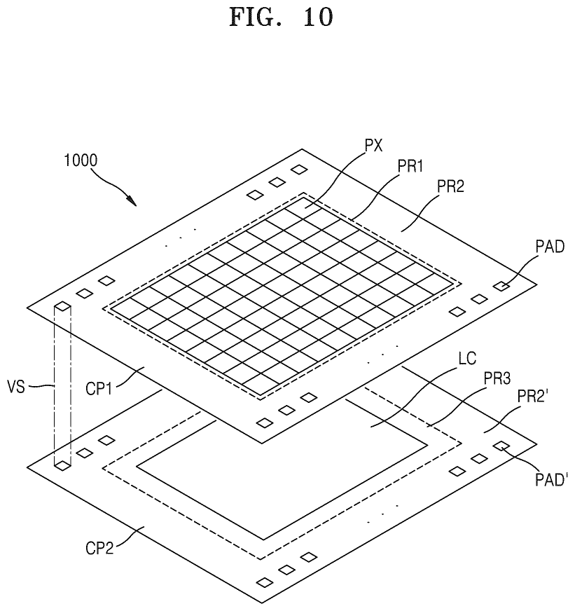

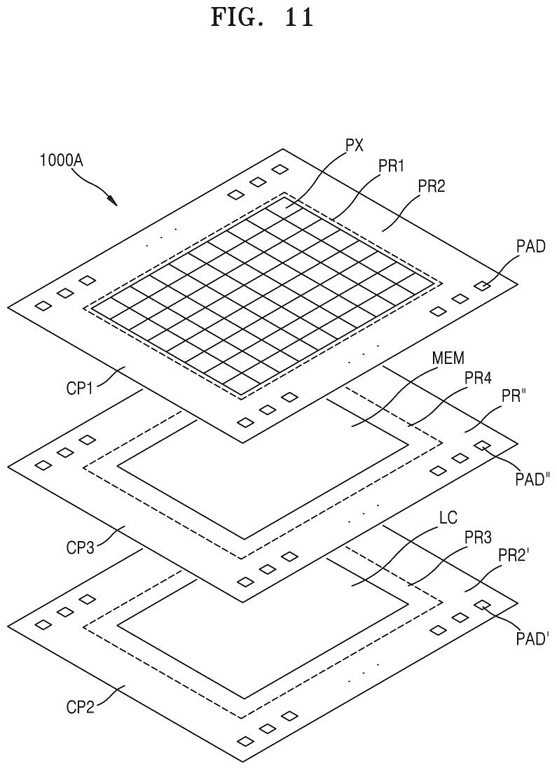

FIGS. 10 and 11 are schematic diagrams illustrating image sensors 1000 and 1000A according to some example embodiments.

Referring to FIG. 10, the image sensor 1000 may be a stack-type image sensor including a first chip CP1 and a second chip CP2 that are stacked in a vertical direction. The image sensor 1000 may be an implementation of the image sensor 14 described with reference to FIGS. 1 and 2.

The first chip CP1 may include a pixel region PR1 and a pad region PR2, and the second chip CP2 may include a peripheral circuit region PR3 and a pad region PR2′. A pixel array in which a plurality of unit pixels PX are arranged may be formed in the pixel region PR1. Each of the plurality of unit pixels PX may be the same as the unit pixel 111 described with reference to FIG. 3A or the unit pixel 111A described with reference to FIG. 3B.

The peripheral circuit region PR3 of the second chip CP2 may include a logic circuit block LC and may include a plurality of transistors. For example, the logic circuit block LC may include at least some of the control circuit 120, the readout circuit 130, the preprocessing circuit 140, the memory 150, the calibration circuit 160, the ISP 170, and the output interface circuit 180 which are described with reference to FIG. 2. The peripheral circuit region PR3 may provide a constant signal to each of the plurality of unit pixels PX included in the pixel region PR1, and may read a pixel signal output from each of the plurality of unit pixels PX. In some example embodiments, a main controller, the ISP 170, and the memory 150 may be arranged in a center portion of the peripheral circuit region PR3, and a photogate driver, the readout circuit 130, the output interface circuit 180, a PLL circuit, and the like may be arranged in an outer portion of the peripheral circuit region PR3 which surrounds the center portion of the peripheral circuit region PR3.

The pad region PR2′ of the second chip CP2 may include lower conductive pads PAD′. The number of lower conductive pads PAD′ may be two or more, and the lower conductive pads PAD′ may respectively correspond to upper conductive pads PAD. The lower conductive pads PAD′ may be electrically connected to the upper conductive pads PAD of the first chip CP1 through via-structures VS.

Referring to FIG. 11, the image sensor 1000A may be a stack-type image sensor including a first chip CP1, a third chip CP3, and a second chip CP2 that are stacked in a vertical direction. The image sensor 1000A may be an implementation of the image sensor 14 described with reference to FIGS. 1 and 2.

The first chip CP1 may include a pixel region PR1 and a pad region PR2. A pixel array in which a plurality of unit pixels PX are arranged may be formed in the pixel region PR1. The second chip CP2 may include a peripheral circuit region PR3 and a pad region PR2′. The peripheral circuit region PR3 of the second chip CP2 may include a logic circuit block LC and may include a plurality of transistors. For example, the logic circuit block LC may include at least some of the control circuit 120, the readout circuit 130, the preprocessing circuit 140, the calibration circuit 160, the ISP 170, and the output interface circuit 180 that are described with reference to FIG. 2.

The third chip CP3 may include a memory region PR4 and a pad region PR″. A memory MEM may be formed in the memory region PR4. The memory MEM may be the same as the memory 150 described with reference to FIG. 2 and may include a frame memory. In addition, the memory MEM may include the memory 16′ described with reference to FIG. 4B.

The pad region PR″ of the third chip CP3 may include conductive pads PAD″. The number of conductive pads PAD″ may be two or more, and the conductive pads PAD″ may be electrically connected to upper conductive pads PAD or lower conductive pads PAD′ through via-structures. The image sensor 1000A of FIG. 11 may have a structure in which the first chip CP1, the third chip CP3, and the second chip CP2 are sequentially stacked, but the image sensor 1000A of the inventive concepts are not limited thereto. The image sensor 1000A may have a structure in which the first chip CP1, the second chip CP2, and the third chip CP3 are sequentially stacked.

When the terms “about” or “substantially” are used in this specification in connection with a numerical value, it is intended that the associated numerical value includes a manufacturing or operational tolerance (e.g., ±10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes.

The system 10 (or other circuitry, for example, the camera module 100, 100a, 100b, the processor 30, the memory module 20, the light source unit 12, the image sensor 14, 14′, the light source driver 210, the light source 220, the pixel array 110, the control circuit 120, the readout circuit 130, the preprocessing circuit 140, the memory 150, the calibration circuit 160, the image signal processor (ISP) 170, the output interface circuit 180, the memory 16, 16′, and sub components thereof) may include hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

While the inventive concepts have been particularly shown and described with reference to some example embodiments thereof, it will be understood that various changes in form and details may be made therein without departing from the spirit and scope of the following claims.

What is claimed is:

1. An image sensor for distance measurement, the image sensor comprising:
a pixel array comprising a plurality of unit pixels;
a readout circuit configured to read out pixel signals from the pixel array in units of sub-frames and generate raw data;
a preprocessing circuit configured to preprocess the raw data to generate phase data;
a memory configured to store the phase data;
a calibration circuit configured to generate correction data by performing a calibration operation on the phase data;
an image signal processor configured to generate depth information using the correction data; and
an output interface circuit configured to output depth data comprising the depth information in units of depth frames.

2. The image sensor of claim 1, wherein the plurality of unit pixels have a 4-tap structure comprising first to fourth taps that respectively are configured to generate first to fourth pixel signals according to first to fourth photogate signals.

3. The image sensor of claim 2, wherein,
in a first sub-frame, the first tap is configured to generate the first pixel signal according to the first photogate signal, the second tap is configured to generate the second pixel signal according to the second photogate signal, the third tap is configured to generate the third pixel signal according to the third photogate signal, and the fourth tap is configured to generate the fourth pixel signal according to the fourth photogate signal,
in a second sub-frame, the first tap is configured to generate the first pixel signal according to the third photogate signal, the second tap is configured to generate the second pixel signal according to the fourth photogate signal, the third tap is configured to generate the third pixel signal according to the first photogate signal, and the fourth tap is configured to generate the fourth pixel signal according to the second photogate signal.

4. The image sensor of claim 3, wherein, based on the first photogate signal, the second photogate signal has a phase difference of 90°, the third photogate signal has a phase difference of 180°, and the fourth photogate signal has a phase difference of 270°.

5. The image sensor of claim 1, wherein the plurality of unit pixels have a 2-tap structure comprising two taps that respectively are configured to generate a first pixel signal and a second pixel signal according to a first photogate signal and a second photogate signal.

6. The image sensor of claim 1, wherein,
in a first sub-frame, the pixel array is configured to generate the pixel signals according to a control signal having a first modulation frequency, and
in a second sub-frame, the pixel array is configured to generate the pixel signals according to a control signal having a second modulation frequency that is different from the first modulation frequency.

7. The image sensor of claim 1, wherein
the calibration circuit is configured to perform the calibration operation based on calibration information, and
the calibration information comprises at least one selected from the group consisting of intrinsic characteristic parameters related to physical characteristics of the image sensor, a wiggling lookup table related to a wiggling effect, a fixed phase pattern noise (FPPN) lookup table related to FPPN, and temperature parameters related to external environment temperatures.

8. The image sensor of claim 7, further comprising a memory is configured to store the calibration information.

9. A camera module comprising:
a light source unit configured to transmit an optical transmission signal to an object; and
an image sensor configured to receive an optical reception signal reflected from the object,
wherein the image sensor comprises:
a pixel array comprising a plurality of unit pixels;
a control circuit configured to transmit a modulation signal to the light source unit and a plurality of demodulation signals to the pixel array, the modulation signal and the plurality of demodulation signals having an identical modulation frequency;
a readout circuit configured to read out pixel signals from the pixel array in units of sub-frames and generate raw data;
a preprocessing circuit configured to preprocess the raw data to generate phase data;
a frame memory configured to store the phase data;
an image signal processor configured to generate depth information based on the phase data; and
an output interface circuit configured to output depth data comprising the depth information in units of depth frames.

10. The camera module of claim 9, wherein
the plurality of unit pixels have a 4-tap structure comprising first to fourth taps configured to receive first to fourth photogate signals included in the plurality of demodulation signals,
based on the first photogate signal, the second photogate signal has a phase difference of 90°, the third photogate signal has a phase difference of 180°, and the fourth photogate signal has a phase difference of 270°.

11. The camera module of claim 10, wherein,
in a first sub-frame, the control circuit is configured to transmit the first photogate signal to the first tap, the second photogate signal to the second tap, the third photogate signal to the third tap, and the fourth photogate signal to the fourth tap,
in a second sub-frame, the control circuit is configured to transmit the third photogate signal to the first tap, the fourth photogate signal to the second tap, the first photogate signal to the third tap, and the second photogate signal to the fourth tap.

12. The camera module of claim 11, wherein the image signal processor is configured to generate depth information corresponding to one depth frame based on a first piece of phase data generated in the first sub-frame and a second piece of phase data generated in the second sub-frame.

13. The camera module of claim 9, wherein,
in a first sub-frame, the control circuit is configured to transmit a plurality of demodulation signals having a first modulation frequency to the pixel array, and
in a second sub-frame, the control circuit is configured to transmit a plurality of demodulation signals having a second modulation frequency that is different from the first modulation frequency to the pixel array.

14. The camera module of claim 13, wherein the image signal processor is configured to generate depth information corresponding to one depth frame based on a first piece of phase data generated in the first sub-frame and a second piece of phase data generated in the second sub-frame.

15. The camera module of claim 9, wherein
the image sensor further comprises a calibration circuit configured to generate correction data by performing a calibration operation on the phase data, and
the image signal processor is configured to generate the depth information using the correction data.

16. The camera module of claim 15, wherein
the calibration circuit is configured to perform the calibration operation based on calibration information, and
the calibration information comprises at least one selected from the group consisting of intrinsic characteristic parameters related to physical characteristics of the image sensor, a wiggling lookup table related to a wiggling effect, a fixed phase pattern noise (FPPN) lookup table related to FPPN, and temperature parameters related to external environment temperatures.

17. The camera module of claim 16, wherein the image sensor further comprises a memory configured to store the calibration information.

18. The camera module of claim 16, further comprising a memory is configured to store the calibration information, and
the image sensor is configured to receive the calibration information from the memory.

19. A camera module comprising:
a light source unit configured to transmit an optical transmission signal to an object; and
an image sensor configured to receive an optical reception signal reflected from the object,
wherein the image sensor comprises:
a pixel array comprising a plurality of unit pixels;
a control circuit configured to transmit a modulation signal to the light source unit and a plurality of demodulation signals to the pixel array, the modulation signal and the plurality of demodulation signals having an identical modulation frequency;
a readout circuit configured to read out pixel signals from the pixel array and generate raw data;
a preprocessing circuit configured to preprocess the raw data to generate phase data;
a memory is configured to store the phase data;
a calibration circuit configured to generate correction data by performing a calibration operation on the phase data based on calibration information;
an image signal processor configured to generate depth information using the correction data; and
an output interface circuit configured to output depth data comprising the depth information.

20. The camera module of claim 19, wherein the camera module is configured to store the calibration information.
